(19) United States
(12) Patent Application Publication
(10) Pub. No.: US 2019/0244204 A1
(43) Pub. Date: Aug. 8, 2019

(54) Method and System for Linkage of Generally Available Healthcare Accounts to Credit Card

(71) Applicant: Mastercard International Incorporated, Purchase, NY (US)

(72) Inventors: Edward McLaughlin, Newtown, PA (US); Mark Wiesman, Chesterfield, MO (US); Matthew Lanford, London (GB)

(21) Appl. No.: 16/272,028

(22) Filed: Feb. 11, 2019

Related U.S. Application Data
(63) Continuation of application No. 12/566,774, filed on Sep. 25, 2009, now abandoned.
(60) Provisional application No. 61/100,078, filed on Sep. 25, 2008.

(51) Int. Cl. G06Q 20/40; G06Q 40/02; G06Q 30/04; G06Q 20/04; G06Q 20/10; G06Q 20/20

(52) U.S. Cl. CPC G06Q 20/40; G06Q 40/02; G06Q 20/20; G06Q 20/04; G06Q 20/105; G06Q 30/04

(57) ABSTRACT

A general-purpose payment card product is linked to a designated reimbursement account. A payment card authorization request is obtained, with a full amount and a reimbursement eligible amount included therein, based on a transaction with the payment card product at a merchant. In one aspect, a payment card authorization response is returned to the merchant from an issuer of the payment card product, based on the full amount. A funding request is initiated, for the reimbursement eligible amount, from the designated reimbursement account. The payment card product and the designated reimbursement account are managed separately. In an alternative, the authorization request is intercepted by an operator of a payment network. The operator initiates a first operator authorization request for the reimbursement eligible amount, and a second operator authorization request for the full amount less the portion of the reimbursement eligible amount, and returns a coordinated response to the merchant.

### CROSS-REFERENCE TO RELATED APPLICATIONS

This patent application is a continuation of U.S. patent application Ser. No. 12/566,774 filed Sep. 25, 2009, which in turn claims the benefit of U.S. Provisional Patent Application Ser. No. 61/100,078 filed Sep. 25, 2008 and entitled “Method and System for Linkage of Generally Available Healthcare Accounts to Credit Card” of inventors McLaughlin, Wiesman, and Lanford. The complete disclosures of the aforementioned patent application Ser. No. 12/566,774 and Provisional Patent Application Ser. No. 61/100,078 are expressly incorporated herein by reference in their entireties for all purposes.

### FIELD OF THE INVENTION

The present invention relates generally to electronic commerce, and, more particularly, to electronic payment systems.

### BACKGROUND OF THE INVENTION

In the marketplace today, there are a number of card products that allow for access to various health care accounts (e.g. flexible spending accounts and/or health savings account (FSA/HSA)). These card products, however, are typically limited to eligible healthcare purchases.

### SUMMARY OF THE INVENTION

Principles of the present invention provide techniques for linkage of generally available healthcare accounts to a credit card or other payment card. An exemplary embodiment of a method (which can be computer-implemented), according to one aspect of the invention, includes the steps of linking a general-purpose payment card product to a designated reimbursement account; and facilitating obtaining a payment card authorization request with a full amount and a reimbursement eligible amount included therein. The request is based on a transaction with the payment card product at a merchant. An additional step includes facilitating returning to the merchant a payment card authorization response from an issuer of the payment card product. The payment card authorization response is based on the full amount. A further step includes facilitating initiating a funding request, for the reimbursement eligible amount, from the designated reimbursement account. The payment card product and the designated reimbursement account are managed separately.

Furthermore, an exemplary embodiment of a method (which can be computer-implemented), according to another aspect of the invention, includes the steps of linking a general-purpose payment card product to a designated reimbursement account; and facilitating obtaining a payment card authorization request with a full amount and a reimbursement eligible amount included therein. The request is based on a transaction with the payment card product at a merchant. Further steps includes facilitating interception of the request by an operator of a payment network; and facilitating initiating a first operator authorization request, by the operator of the payment network. The first operator authorization request is for the reimbursement eligible amount, from an issuer entity associated with the designated reimbursement account. An additional step includes facilitating initiating a second operator authorization request, by the operator of the payment network, for the full amount less the reimbursement eligible amount, but plus any uncertain portion of the reimbursement eligible amount, from an issuer of the payment card product. Another additional step includes facilitating returning to the merchant a coordinated payment card authorization response. The payment card product and the designated reimbursement account are managed separately.

Aspects of the invention contemplate the method(s) performed by one or more entities herein, as well as facilitating (as defined below) of one or more method steps by the same or different entities.

In another aspect, an exemplary apparatus includes a registration site module comprising a registration site memory, at least one registration site processor coupled to the registration site memory, and a distinct registration site software module, embodied on a registration site tangible computer-readable recordable storage medium, executable by the registration site processor to link a general-purpose payment card product to a designated reimbursement account. The apparatus further includes a payment network platform module, coupled to the registration site module (directly or indirectly), and comprising a payment network platform memory, at least one payment network platform processor coupled to the payment network platform memory, and a distinct payment network platform software module, embodied on a payment network platform tangible computer-readable recordable storage medium, executable by the payment network platform processor to receive a payment card authorization request with a full amount and a reimbursement eligible amount included therein, based on a transaction with the payment card product at a merchant. Yet further, the apparatus includes an issuer platform module, coupled to the payment network platform module, and comprising an issuer platform memory, at least one issuer platform processor coupled to the issuer platform memory, and a distinct issuer platform software module, embodied on an issuer platform tangible computer-readable recordable storage medium, executable by the issuer platform processor to facilitate returning to the merchant a payment card authorization response. The payment card product and the designated reimbursement account are managed separately. At least one of the issuer platform module and the payment network platform module is configured to facilitate initiating a funding request, for the reimbursement eligible amount, from the designated reimbursement account.

One or more embodiments of the invention or elements thereof can be implemented in the form of a computer product including a tangible computer readable recordable storage medium with computer usable program code for performing the method steps indicated. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable recordable storage medium (or multiple such media).

One or more embodiments of the invention can provide substantial beneficial technical effects, for example:
allows use of only a single card at the point-of-sale, as opposed to multiple cards
issuers and other entities only need to issue a single card
reduces or eliminates need for merchants to develop links to multiple networks (i.e., for both healthcare funding and conventional credit/debit processing)

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a general example of a payment system that can implement techniques of the invention;

FIG. 2 shows exemplary data flow;

FIG. 3 is a background flow chart;

FIG. 4 is another background flow chart;

FIG. 5 is a block diagram of an exemplary computer system useful in one or more embodiments of the invention;

FIGS. 6-9 are exemplary block and data flow diagrams of four exemplary and non-limiting embodiments of the invention; and

FIG. 10 depicts an exemplary inter-relationship between and among: (i) a payment network configured to facilitate transactions between multiple issuers and multiple acquirers, (ii) a plurality of users, (iii) a plurality of providers or other merchants, (iv) a plurality of acquirers, and (v) a plurality of issuers.

### DETAILED DESCRIPTION OF PREFERRED EMBODIMENTS

One or more embodiments of the invention provide a method for linking generally available health care accounts to payment card products, such as credit cards, debit cards, or stored value cards. These products can be used for everyday purchases, as well as to provide linkage to health care eligible accounts for open-to-buy account reimbursement. Such payment card products may be configured according to a credit or debit card type payment system standard or specification and can be designed for use in a conventional credit or debit card environment (for example, of the kind as shown in FIG. 10), and are typically nearly universally accepted worldwide by merchants of all kinds (as opposed to dedicated cards which can only make health-related purchases).

In one or more embodiments, prior to making any purchase, the cardholder will be required to register his or her healthcare account information. This information will be used to provide the linkage between the credit card used at the merchant point of sale (POS) and the health funding account. For the first embodiment discussed below, this can be provided, for example, by either the merchant (e.g., drug store) or the issuer. In the second through fourth embodiments discussed below, an operator of a payment network (MasterCard International Incorporated of Purchase, N.Y., USA is a non-limiting example) is one example of an entity that can provide this functionality. In at least some instances, existing assets used for transit applications and the like can be leveraged.

Aspects of the invention provide a method for linking a health care account from any provider to a credit (or other payment card) product, as opposed to merely providing multi-purpose healthcare accounts such as a debit healthcare account with linkage to a line of credit wherein a company provides linkage only to the accounts that they manage.

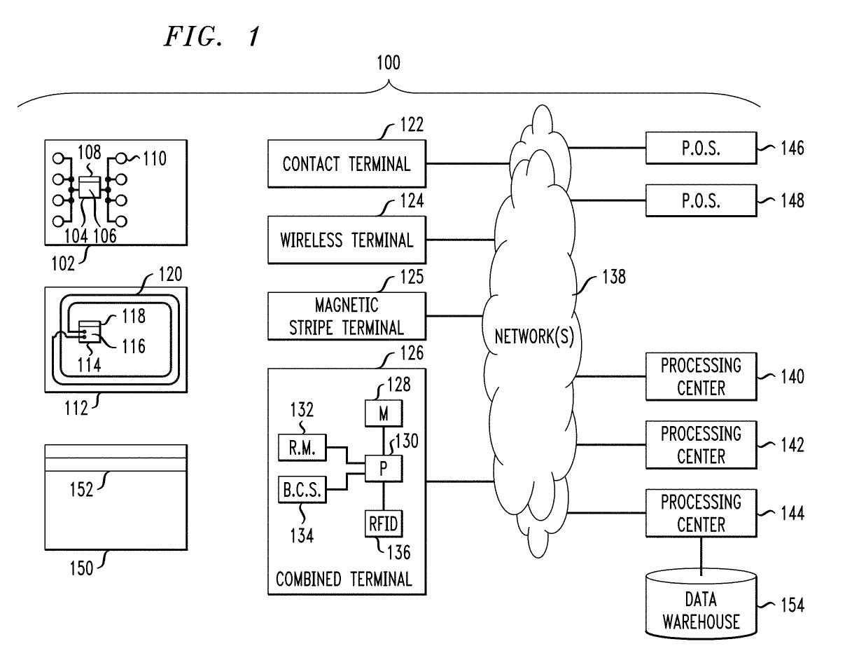

Attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the invention. Other types of devices used in lieu of or in addition to “smart” or “chip” cards 102, 112 could include a conventional card 150 having a magnetic stripe 152, an appropriately configured cellular telephone handset, and the like. Indeed, techniques of the invention can be adapted to a variety of different types of cards, terminals, and other devices.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's personal identification number (“PIN”) and/or primary account number (“PAN”). The memory portions or units 108, 118 can store the operating system of the cards 102, 112. The operating system loads and executes applications and provides file management or other basic card services to the applications. One operating system that can be used to implement the present invention is the MULTOS® operating system licensed by MAOSCO Limited. (MAOSCO Limited, St. Andrews House, The Links, Kelvin Close, Birchwood, Warrington, WA3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible standard to which such applications may conform is the EMV payment standard set forth by EMVCo, LLC (901 Metro Center Boulevard, Mailstop M3-3D, Foster City, Calif., 94404, USA). It will be appreciated that applications can be configured in a variety of different ways.

As noted, cards 102, 112 are examples of a variety of payment devices that can be employed with techniques of the invention. The primary function of the payment devices may not be payment, for example, they may be cellular phone handsets that implement techniques of the invention. Such devices could include cards having a conventional form factor, smaller or larger cards, cards of different shape, key fobs, personal digital assistants (PDAs), appropriately configured cell phone handsets, or indeed any device with the capabilities to implement techniques of the invention. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more method steps. The applications can be, for example, application identifiers (AIDs) linked to software code in the form of firmware plus data in a card memory such as an electrically erasable programmable read-only memory (EEPROM). Again, note that “smart” or “chip” cards are not necessarily required and a conventional magnetic stripe card can be employed.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network. More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. In one or more embodiments of the invention, various establishments may interface with a telecommunications network, such as a virtual private network (VPN), via one or more machines which are then connected to the network. This will be discussed further below. Each such establishment can have one or more terminals. Further, different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

Again, conventional magnetic stripe cards 150 can be used instead of or together with “smart” or “chip” cards.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 128, which then contactlessly transmits the electronic data to the proximity IC chip in the card 112 or other wireless device.

One or more of the processing centers 140, 142, 144 can include a database such as a data warehouse 154.

With reference to FIG. 10, an exemplary relationship among multiple entities is depicted. A number of different users 2002, U₁, U₂ . . . U_{N}, interact with a number of different merchants 2004, P₁, P₂ . . . P_{M}. Users 2002 could be, for example, holders of general purpose payment cards. Merchants 2004 (e.g., health care providers, pharmacies) interact with a number of different acquirers 2006, A₁, A₂ . . . A_{I}. Acquirers 2006 interact with a number of different issuers 2010, I₁, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. Authorized transactions are stored in “batches,” which are sent to the acquirer 2006. During clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 10 is an example of a payment network configured to facilitate transactions between multiple issuers and multiple acquirers, which may be thought of as an “open” system. Some embodiments of the invention may be employed with other kinds of payment networks, for example, proprietary or closed payments networks with only a single issuer and acquirer, such as the AMERICAN EXPRESS network (mark of American Express Company). In such a case, this single entity could function as the issuer and could approve a full amount and seek reimbursement from the health care company, or could seek approval “up front” from the health care company, and fund the remaining part. That is to say, the operator of a proprietary or closed payment network could implement the functionality discussed below with respect to the first through fourth exemplary embodiments, in the role of the issuer, the payment network operator, or both.

One beneficial feature of one or more embodiments of the invention is the reduction or elimination of cardholders being declined when seeking to make a purchase of at least some healthcare-eligible items. For example, in an FSA wherein the individual seeks to put away $1000, such funds may be available as of January 1. However, in the case of an HSA, only actual balances accrued to date are available. Thus, some embodiments allow payment of the entire amount with the general-purpose payment card account, and then seek reimbursement from the FSA or HSA to help with the payment. It will be appreciated that aspects of the invention require a determination that some goods or services purchased are eligible for reimbursement and some are not. In a currently preferred approach, this determination can be made locally, at a merchant, and a POS system of the merchant (or a server or other computer in communication with same) could total up the overall purchase amount and the portion eligible for reimbursement. In a currently most preferable approach, the merchants are IIAS-compliant, as discussed elsewhere herein, and authorization messages include both a total amount field and an eligible amount field, the eligible amount field being determined locally in accordance with IIAS. For example, there could be a $100 total amount and a $30 healthcare-eligible amount.

In an alternative approach, indicia identifying the items purchased could be sent elsewhere, and a determination as to eligibility could be made elsewhere. One possible manner of accomplishing this latter approach is set forth in US Patent Publication No. 2008-0011820 of Brown et al., entitled “Method and System for Enabling Item-Level Approval of Payment Card.” Furthermore, in some instances, the architecture depicted in US Patent Publication No. 2008-0011820 is modified to implement one or more techniques or aspects of the invention, whether or not translation of indicia or remote determination of eligibility is required. The complete disclosure of the aforesaid US Patent Publication No. 2008-0011820 is expressly incorporated herein by reference in its entirety for all purposes.

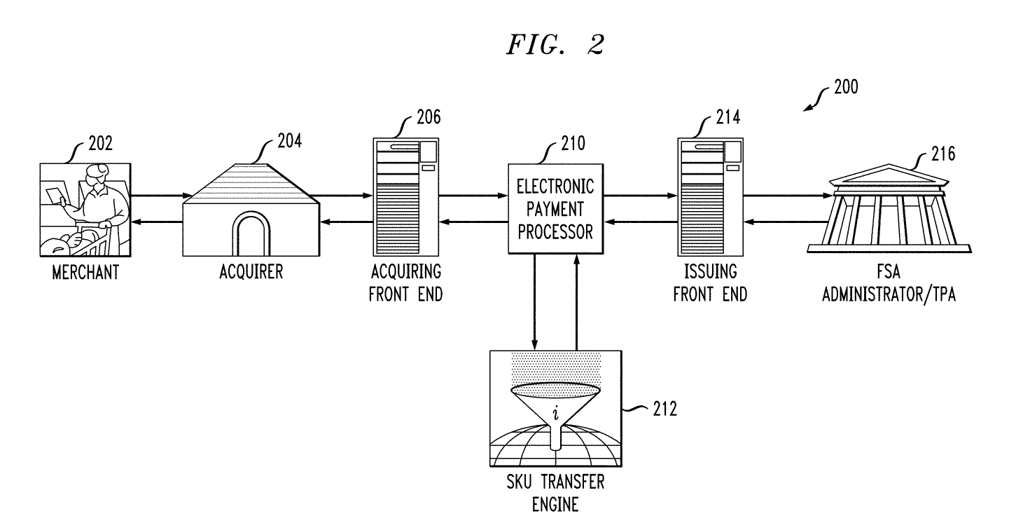

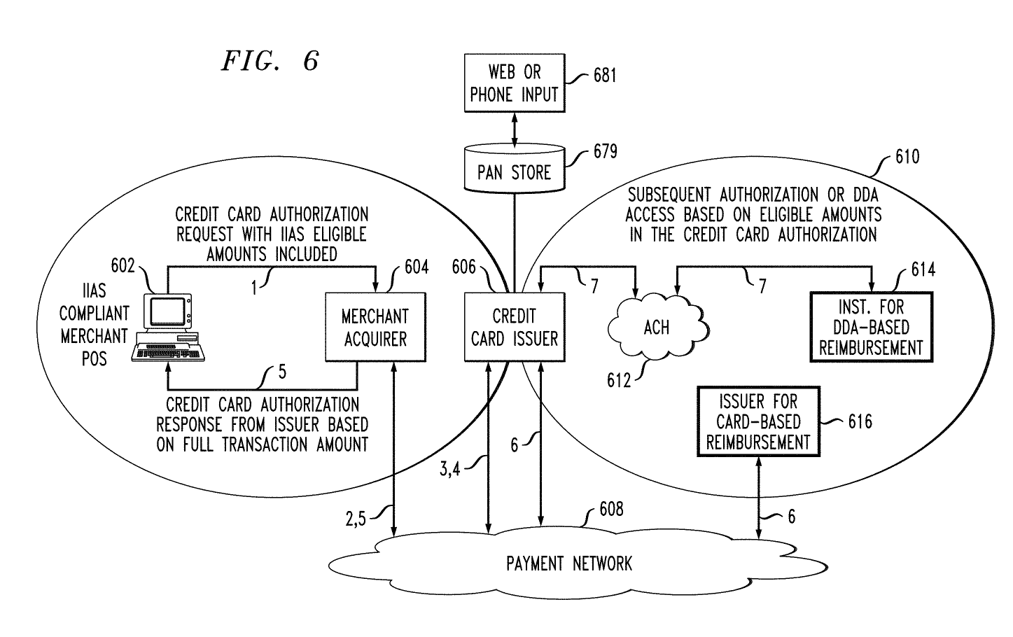

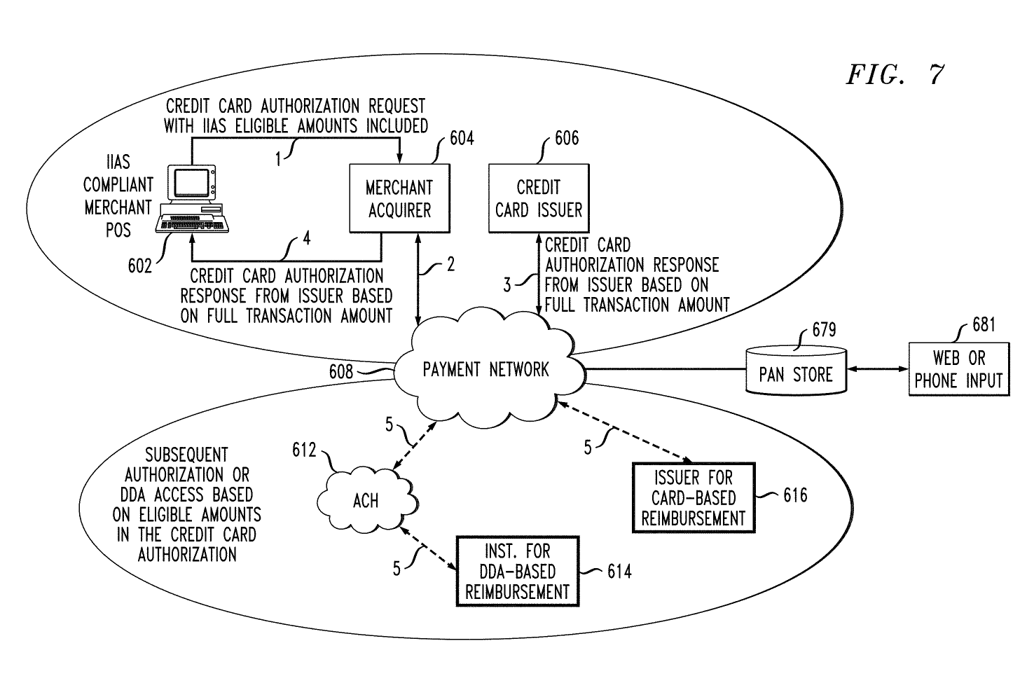

Attention should now be given to FIG. 2, which is a block diagram 200 of one exemplary system, also depicting (via the arrows) data flow. FIG. 2 shows a system wherein item-level data is passed from merchant 202 to a party 216 to determine whether specific items are FSA or HSA eligible. It is to be emphasized that embodiments of the invention, such as those in FIGS. 6-9 below, may work in a variety of ways. For example, the amount of a purchase believed to be FSA or HSA eligible may be obtained or estimated locally at a merchant, based on a database of a merchant, or might be determined by a third party in a number of different ways besides that shown in FIG. 2.

As shown at 202, the holder of a card or other payment device interacts with a terminal at a point of interaction, such as a facility of a merchant or other card acceptor, corresponding, e.g., to terminals and points of sale as described with respect to FIG. 1. The card acceptor sends transaction information to an acquirer 204 (equivalent to acquirer 2006 in FIG. 10), for example, via a network such as described in FIG. 1 or as described in FIG. 10. The merchant can provide indicia such as stock keeping unit (SKU) numbers, universal product codes (UPCs), and/or national drug codes (NDCs). “SKU” is a common term for a unique numeric identifier, used most commonly in online business to refer to a specific product in inventory or in a catalog. The indicia can be provided in an authorization request. A front end processor 206 can be provided between acquirer 204 and electronic payment processor 210 (e.g., a virtual private network (VPN) of a single operator of a payment network 2008 configured to facilitate transactions between multiple issuers and multiple acquirers, or a third party acting on behalf of such an operator). Front end processor 206 can be located in a variety of places, e.g., at the acquirer's facility. One example of a suitable front end processor 206 is a MASTERCARD INTERFACE PROCESSOR™ or MIP™ processor (trademarks of MasterCard International, Inc. of Purchase, N.Y.).

The skilled artisan will of course appreciate that in this context, “processor” 210 means, e.g., an entity having a VPN or other network, and the like, while “processor” 206, 214 means a specific piece of hardware such as a microprocessor.

The acquirer 204 can forward the indicia, for example, via processor 206, payment network 210, and issuer front end processor 214, to health care administrator 216. In US Patent Publication No. 2008-0011820, and in some instances of the present invention, the indicia can be first forwarded to a transfer engine 212. The transfer engine is depicted in FIG. 2 as an “SKU Transfer Engine” but it should be understood that it can process a wide variety of indicia as discussed herein. Engine 212, in some cases, receives the authorization request or similar message and translates the indicia into a form understandable by Third Party Administrator 216. The translated indicia can be populated into the authorization request, which is then forwarded by engine 212 to block 216. This forwarding can be via payment network 210. It is to be understood that the invention in is not limited to healthcare applications. For example, in other instances, one or more embodiments have applicability to the field of government benefits, such as food stamps of the like, wherein certain items are eligible for purchase with food stamps and certain other items are not.

It should be noted that the translation functionality described herein is optional. It may be useful, for example, to translate any non-standard merchant indicia into a UPC or other indicia understandable by the program manager 216.

Block 214 can represent, for example, another front-end processor, such as a MIP™, and can be located, e.g., at the facility of an administrator 216 to provide access to the aforementioned VPN of processor 210. Of course, there may be a plurality of similarly-equipped issuer, and other, facilities. Furthermore, it is to be emphasized that the specific configuration shown in FIG. 2 is exemplary in nature. Other approaches can be employed.

Third party administrator 216 can match the translated indicia against a database containing, for example, lists of eligible items under a given health (or other) plan, can approve individual values, and can sum the approved amount. The approved amount can be provided in a response message to be returned to the merchant 202 through the reverse of the path just described, as shown by the return arrows. Note that the third party approver may maintain a database listing eligible items, while the engine 212 may maintain a database for translation.

Front end processors, such as processor 206, 214, and VPNs, such as the VPN of processor 210, are well-known to skilled artisans. In one specific example, the processors 206, 214 are (as noted) MIP™ processors, and the VPN of processor 210 is a telecommunications network providing MASTERCARD BANKNET® telecommunications network services (registered trademark of MasterCard International, Inc. of Purchase, N.Y.).

Note again that in some cases, a conventional architecture can be used wherein engine 212 is omitted, front ends 206 and 214 are optional, and block 216 is representative of an administrator of an HSA, FSA, or the like.

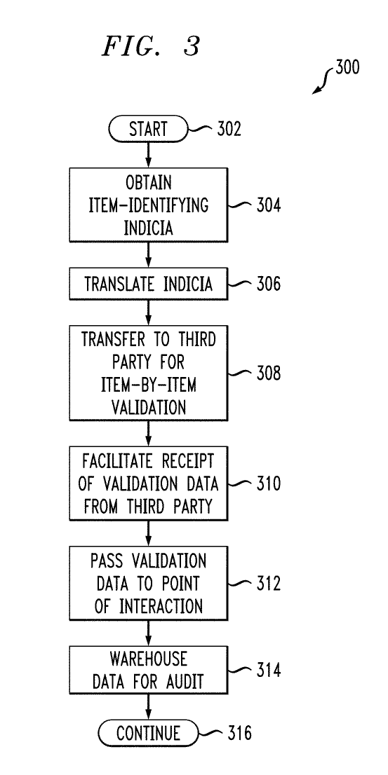

FIG. 3 presents a flow chart 300 of method steps for electronic payment validation, adapted from US Patent Publication No. 2008-0011820. After beginning at block 302, at step 304, a step of facilitating obtaining indicia identifying individual items to be purchased at a point of interaction, in conjunction with an inbound authorization request, can be conducted. The indicia can include, e.g., SKUs, UPCs, NDCs, and the like. The individual items to be purchased can include products and/or services. The point of interaction can be any place where the transaction takes place, e.g., a doctor's office, a merchant such as a drug store, etc. The flow in FIG. 3 is presented from the perspective of payment network 210 with optional transfer engine such as element 212, and the inbound authorization request is thus inbound from acquirer 204. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

Optional step 306 includes facilitating translation of the indicia into a form understandable by a third party transaction approver, such as administrator 216, to obtain translated indicia. Step 308 includes facilitating transfer of the (optionally, translated) indicia to the third party transaction approver for item-by-item validation on the individual items. The transfer of the translated indicia is in conjunction with an outbound authorization request (e.g., outbound from network 210 and optionally engine 212 to block 216).

Further possible steps include steps 310 and 312. Step 310 includes facilitating receipt of validation data associated with the item-by-item validation on the individual items from the third party transaction approver. The data could include, for example, a total sum approved and/or item-by-item approvals. The item-by-item validation is based at least on matching of the (optionally, translated) indicia against a database. Note, in one or more embodiments, even when only a total approved sum is included in the data, items are still validated by issuer 216 on an item-by-item basis. Step 312 includes facilitating passage of the validation data in a response message to be routed to the point of interaction.

As noted, the validation data can include a total approved reimbursable monetary amount reflecting a total price of those of the items that are valid for reimbursement. The total approved monetary amount is no greater than the total purchase price of the individual items to be purchased (inclusive of any appropriate tax, as will be discussed further hereinafter). In another aspect, the validation data comprises flags for each of the individual items, and the flags indicate whether a given one of the items is valid. If desired, both a total approved amount and flags can be included.

In step 304, the indicia identifying the individual items may be obtained, in conjunction with the inbound authorization request.

Optional step 314 includes warehousing (e.g., in a data warehouse such as 154) at least the translated indicia and the validation data for audit, subject to all applicable privacy laws, rules, regulations, policies, and procedures.

In one or more embodiments, the third party transaction approver is associated with an issuer of a healthcare card, and the database contains at least indications of whether a given translated indicia represents an item reimbursable by the issuer of the healthcare card. By way of example, a card holder might purchase gauze bandages, aspirin and cigarettes; the first two items would be reimbursable but not the cigarettes. Where the items include drugs, the indicia identifying the items can further include time-period-supply-data (e.g., a thirty-, sixty-, or ninety-day supply of a given medication).

Processing continues at block 316.

Note that FIG. 3 is of a background nature and in one or more embodiments, such as in FIGS. 6-9, the eligible amounts could be obtained in a variety of ways; for example, step 304 could be carried out as described and step 308 could be carried out by the third party or locally by the merchant. Translation 306 may be omitted in one or more instances as eligibility might be based simply on a database correlating un-translated SKU or the like with eligibility. Such a database could be at the merchant's facility (store or data center, e.g.) or at a third party location if a third party checked items for validity.

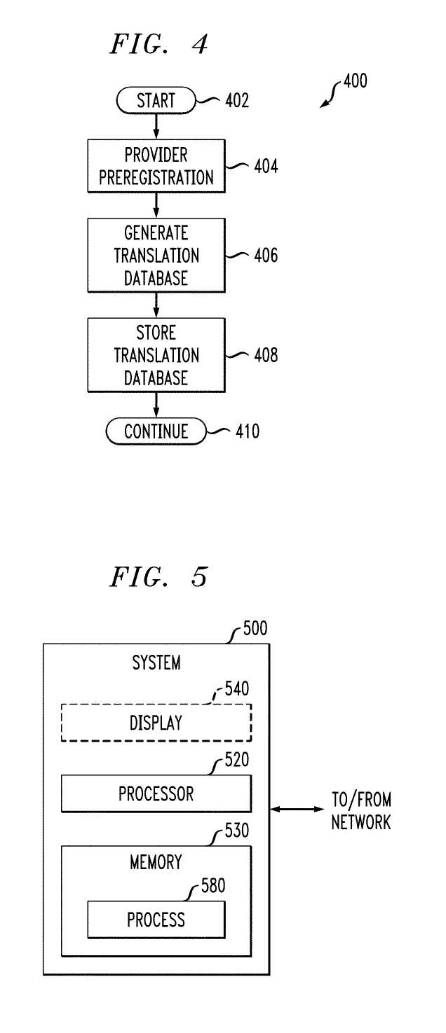

FIG. 4 shows a background flow chart 400 for building a database useful in facilitating electronic payment validation. As noted just above, in one or more embodiments, such as FIGS. 6-9, translation may not be needed. At this point it should also be noted that while the methods described with regard to FIGS. 3 and 4 or otherwise can be computer-implemented, in one or more exemplary embodiments, they may also include one or more manual steps, or a combination of manual and computer-aided steps. After beginning at block 402, step 404 includes facilitating obtaining, via pre-registration of a plurality of providers (e.g., merchants, pharmacies, doctors, etc.), provider indicia (e.g., SKU, UPC, drug code, and the like) identifying individual items (products and/or services) to be purchased, together with identities and costs of the items. At least some of the provider indicia may differ, among given ones of the providers, for an identical one of the items to be purchased. That is, by way of example, Smith's Pharmacy and Baker's Pharmacy may use different SKUs for an identical package of adhesive bandages.

Step 406 includes facilitating generating a translation database having a single translated indicia associated with each given one of the items, regardless of whether given ones of the providers have different provider indicia associated with the given one of the items. That is, the package of adhesive bandages is identified by a single unique (translated) identifier, regardless of the fact that Smith and Baker each use a different identifier for it. In another aspect, indicia of all eligible products could be translated to a single eligibility flag.

Step 408 includes facilitating storage of the translation database in a form to facilitate ready translation of a given provider indicia into a corresponding translated indicia, based on the given provider indicia and an identity a given one of the providers associated with the given provider indicia. That is, given the identity of the pharmacy or other provider and its SKU for the product, the universal identifier can be looked up so that the third party can render an approve/disapprove decision.

Processing continues at step 410.

It is to be emphasized that FIG. 4 represents an example of construction of a translation database, which is an optional feature of the approach wherein a third party determines product reimbursement eligibility, and that local determination by the merchant is currently preferred to such an approach.

For purposes of illustrative convenience, not every block in the figures includes the word “facilitate,” but it will be understood that the method depicted broadly include facilitation of the indicated actions as well as their actual performance.

By way of summary and provision of additional detail, the inbound authorization request discussed above can contain information that includes the cost per item and the identity of the item. To sum the properly approved amount, such information can also include sales tax or value added tax (VAT) information. This cost and tax information need not be in the database maintained by the third party approver. Cost for each item need not be included in the translation database, but may be passed to the engine 212 from the merchant in the authorization request along with the indicia. As noted above, quantity can come into play in the case of prescription and/or over-the-counter (OTC) drugs (i.e. 30 day supply vs. 90 day supply) and could be passed in the authorization request to the third party approver. The third party would then make decisions at the per-item level based on the data provided in the authorization request. While cost of the item need not be part of the decision, it could be taken into account. Furthermore, while in current FSA and HSA schemes quantity typically does not impact eligibility for reimbursement, quantity may be pertinent in checking eligibility in at least some cases.

Again, note that FIGS. 2-4 and accompany text just above are of a background nature and depict a non-limiting context. Aspects of the invention, such as the exemplary embodiments below, may be practiced in a variety of different contexts, for example, where eligibility is determined locally and the authorization request simply includes a total amount and an amount for eligible items, without identifying the items.

The skilled artisan will appreciate that the Internal Revenue Service (IRS) requires certain non-healthcare retailers—including supermarkets, grocery, discount stores, wholesale clubs and mail-order merchants—to implement an Inventory Information Approval System (IIAS) in order for consumers with Flexible Spending Account (FSA) and Health Reimbursement Arrangement (HRA) cards to be able to make purchases of eligible healthcare products or prescriptions. The skilled artisan will be familiar with SIGIS, the special interest group for IIAS standards, and, given the teachings herein, will be able to implement embodiments of the invention in conformance with IIAS. It should be understood, however, that while IIAS-compliant POS terminals are shown in FIGS. 6-9, other types of terminals, systems, and standards can be employed in other embodiments.

### First Exemplary Embodiment

With reference to FIG. 6, in a first exemplary embodiment, a transaction flow includes two separate events. The first event is the original authorization request including the total purchase amount of the requested authorization from the originating merchant. This total purchase amount includes any eligible amounts (e.g., healthcare, food stamps) separately designated as such in the authorization request message.

Note that in any of the exemplary embodiments discussed herein, the general-purpose payment card product and the designated reimbursement (e.g., healthcare, food stamps) account can be managed separately; in at least some cases, by different and unrelated entities. Furthermore, any of the exemplary embodiments discussed herein can make use, for example, of ISO 8583, which is essentially open and used by MasterCard International Incorporated, Visa International Service Association, other networks, terminals, and so on. All versions (e.g., 1987, 1993, 2003) of the ISO 8583 Standard for Financial Transaction Card Originated Messages—Interchange message specifications, promulgated by the International Organization for Standardization, are expressly incorporated herein by reference in their entirety for all purposes. Individual entities or groups may develop specifications within this standard.

Furthermore, one or more exemplary embodiments can make use of appropriate messages and/or data elements or sub-elements within ISO 8583; for example, Authorization Request/0100 and Authorization Request Response/0110 messages with an appropriate user-defined or other DE (data element) or sub-element (the skilled artisan is familiar with user- and ISO-defined data elements in general, and, given the teachings herein, can adapt same to implement one or more embodiments of the invention; for example, an 0100 message with a total amount field and an eligible amount field). In a non-limiting embodiment, some or all messages (for example, authorization request and response) are defined within ISO 8583 and/or within a specification conforming thereto. Other types of messages could be used in other instances. Other embodiments might convey the same, similar, or other information using the same elements and/or sub-elements, different elements and/or sub-elements, or even a standard or specification other than ISO 8583.

The skilled artisan will appreciate that 0100 and 0110 are examples of Message Type Indicators (MTI); the MTI includes the ISO 8583 version, the Message Class, the Message Function and the Message Origin. One or more embodiments make use of ISO 8583 messages which include a field for “additional amounts” and suitable data to characterize the additional amount(s) for different types of payments.

As indicated by arrow 1 in FIG. 6, the merchant 602 sends the properly formatted authorization request, along with eligible reimbursement amounts, to the merchant acquirer 604 for processing. The acquirer 604 forwards the authorization request, with eligible amount fields, to payment network operator 608 for processing, as per arrow 2 in FIG. 6. Note: notation such as “2,5” refers to a double headed arrow with “2” being one of the flows and “5” being another of the flows. Note that references to a “payment network operator” refer to an operator of such a network operating according to a payment standard and/or specification. Non-limiting examples of the payment network include those of the kind configured to facilitate transactions between multiple issuers and multiple acquirers; for example, virtual private networks (VPNs) such as the BANKNET® network of MasterCard International Incorporated or the VISANET® network of Visa International Service Association.

Note that elements 679, 681 will be discussed below in the “Recapitulation” section.

As per arrow 3 in FIG. 6, the payment network operator forwards the authorization request, with eligible amount fields, to the designated credit card issuer 606. Note that the designated credit card issuer refers to the issuer of the general-purpose credit card to which the reimbursement account(s) is/are linked. Furthermore, in the broader sense, in any of the embodiments, this card could be any kind of payment card, e.g., credit, debit, stored value, prepaid, and the like. As per arrows 4 and 5 in FIG. 6, the credit card issuer 606 makes an authorization approval or decline decision based on the total amount of the authorization (which includes the reimbursement-eligible amounts); the issuer 606 generates the appropriate authorization response and returns it back to the merchant 602 through the same network path 608, 604. This can be based, for example, on the open to buy amount in the credit card account, and there would be a decline if the open to buy amount is insufficient, even if the total of open to buy and available reimbursement funds was sufficient. While this is somewhat disadvantageous to the cardholder, it allows for a simple processing approach. In the case of a debit card, stored value card, or prepaid card, the decision is based on the corresponding open to buy (i.e., amount available in DDA or stored balance, as the case may be, less any holds, as opposed to unused portion of credit line).

Separate from the credit card point-of-sale (POS) transaction, the credit card issuer 606 initiates the funding reimbursement request from the designated reimbursement account. This could be via a card based product (e.g. an FSA debit card for an FSA (flexible spending account)) or a DDA (demand deposit, e.g., checking account, in, for example, the case of an HSA (health savings account)), as indicated by arrows 6 and 7, respectively, in FIG. 6. Again, health care examples are non-limiting. As indicated at 610, for card based products, the issuer 606 (of the general-purpose card) will submit a subsequent authorization based only on the amount of the eligible expenses, while for DDA based products, the issuer 606 (of the general purpose card) will generate an ACH transaction to access the eligible funds. Note automated clearing house (ACH) 612, demand deposit account (DDA) institution for DDA-based (e.g., HSA) reimbursement 614, and issuer for card-based (e.g., FSA) reimbursement 616. Institution 614 is analogous to the card issuer 616 and is, for example, the entity that controls the HSA; e.g., bank or other depository financial institution, brokerage, insurance company, and the like.

By way of further clarification, in the case where the generally available healthcare (or other reimbursement) account is itself card based, the issuer 606 of the general purpose card submits an authorization request to issuer 616 via payment network operator 608, as if it were a merchant seeking payment for goods or services. In the case where the generally available healthcare (or other reimbursement) account is DDA based, the issuer 606 of the general purpose card generates the aforementioned ACH or other electronic funds transfer (EFT) transaction. Note that in a current approach, when a person buys something at a drug store with his or her FSA card, on the statement, the name of the drug store will appear. In one or more embodiments, however, the transaction that debits the FSA is coming from another party (here, the card issuer 606). Statements should nevertheless reflect who the “real” merchant is, i.e., the drug store and not the issuer. When implementing one or more embodiments of the invention, appropriate tracking may be set up if needed in light of legal, tax accounting or other business considerations.

Thus, the flow of funds is as follows. The issuer 606 deposits the entire transaction amount (eligible and ineligible), less any applicable discount amount (i.e., processing fee) into the account of merchant 602 at the merchant's acquirer 604. The issuer 606 obtains reimbursement for the eligible amounts from the appropriate reimbursement account (via card or EFT processes just discussed) and then bills the holder of the general purpose card for the ineligible amounts.

It should be noted that in any of the embodiments, because a payment card is being used, a rapid authorization response is expected with respect to the purchase.

### Second Exemplary Embodiment

With reference to FIG. 7, this embodiment differs from the first in that the payment network operator is responsible for delayed processing of the eligible amounts. As per arrow 1 in FIG. 7, the merchant 602 sends the properly formatted authorization request, along with eligible amounts, to the merchant acquirer 604 for processing. As per arrow 2 in FIG. 7, the acquirer 604 forwards the authorization request, with eligible amount fields, to payment network operator 608 for processing. Note that numbered arrows in the different FIGS. 6-9 do not necessarily refer to the same step; i.e., a step with a given number in FIG. 6 and a step with the same given number in FIG. 7 are not necessarily the same step. However, blocks numbered 6XX are intended to refer to similar entities in each of FIGS. 6-9.

As per arrow 3 in FIG. 7, payment network operator 608 forwards the authorization request, with eligible amount fields, to the designated (general purpose) credit card issuer 606. The credit card issuer 606 makes an authorization approval or decline decision based on the total amount of the authorization (which includes the eligible amounts). The issuer 606 generates the appropriate authorization response and returns it back to the merchant 602 through the same network path 608, 604, as per return (double-sided) arrows 3 and 2 and arrow 4. As discussed above with respect to the first embodiment, this authorization can be based, for example, on the open to buy amount in the credit card account, and there would be a decline if the open to buy amount is insufficient, even if the total of open to buy and available reimbursement funds was sufficient. While this is somewhat disadvantageous to the cardholder, it allows for a simple processing approach. In the case of a debit card, stored value card, or prepaid card, the decision is based on the corresponding open to buy (i.e., amount available in DDA or stored balance, as the case may be, less any holds, as opposed to unused portion of credit line).

Separate from the credit card POS transaction at merchant POS 602, payment network operator 608 will initiate the funding reimbursement request from the designated account, as per arrows 5 in FIG. 7. Again, this could be via a card based product (e.g. for FSA accounts in the case of healthcare) or a DDA account (e.g. for HSA accounts in the case of healthcare), as discussed above. For card based products, the payment network operator 608 submits a subsequent authorization based only on the amount of the eligible healthcare (or other eligible) expenses. For DDA based products, the payment network operator 608 will generate an ACH transaction to access the eligible funds.

By way of further clarification, in the case where the generally available healthcare (or other reimbursement) account is itself card based, the payment network operator 608 submits an authorization request to issuer 616, as if it were a merchant seeking payment for goods or services. In the case where the generally available reimbursement account is DDA based, payment network operator 608 generates the aforementioned ACH or other electronic funds transfer (EFT) transaction. As discussed above, statements should reflect who the “real” merchant is, i.e., the drug store and not the payment network operator 608. When implementing one or more embodiments of the invention, appropriate tracking may be set up if needed in light of legal, tax accounting or other business considerations.

Thus, the flow of funds is as follows. The issuer 606 deposits the entire transaction amount (eligible and ineligible), less any applicable discount amount (i.e., processing fee) into the account of merchant 602 at the merchant's acquirer 604. The payment network operator 608 obtains reimbursement for the eligible amounts from the appropriate account (via card or EFT processes just discussed) and forwards same to issuer 606, which then bills the holder of the general purpose card for the ineligible amounts.

### Third Exemplary Embodiment

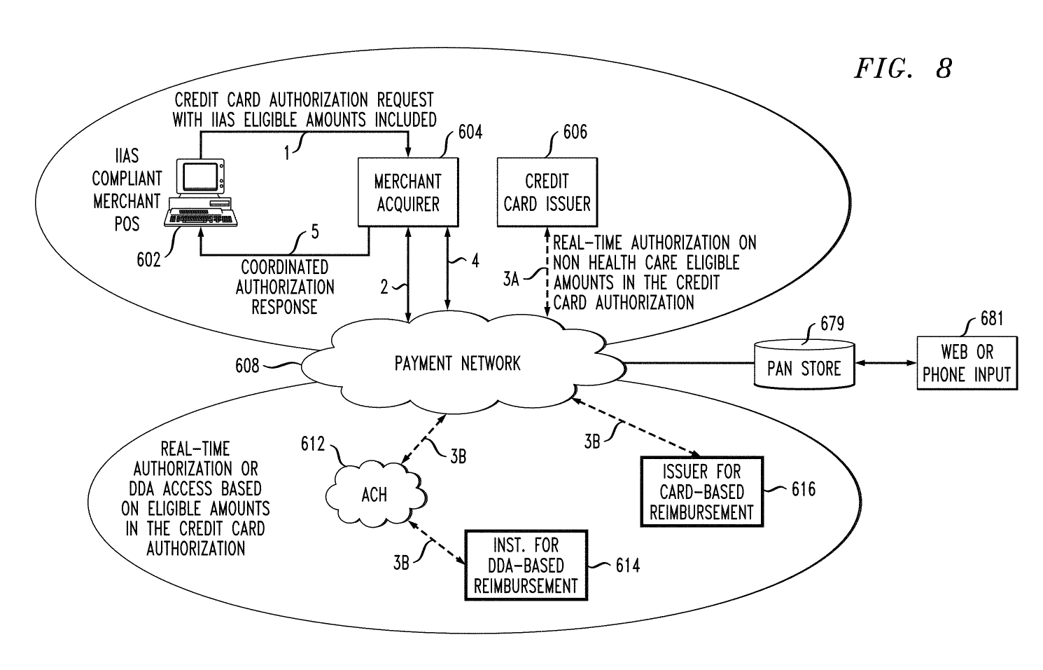

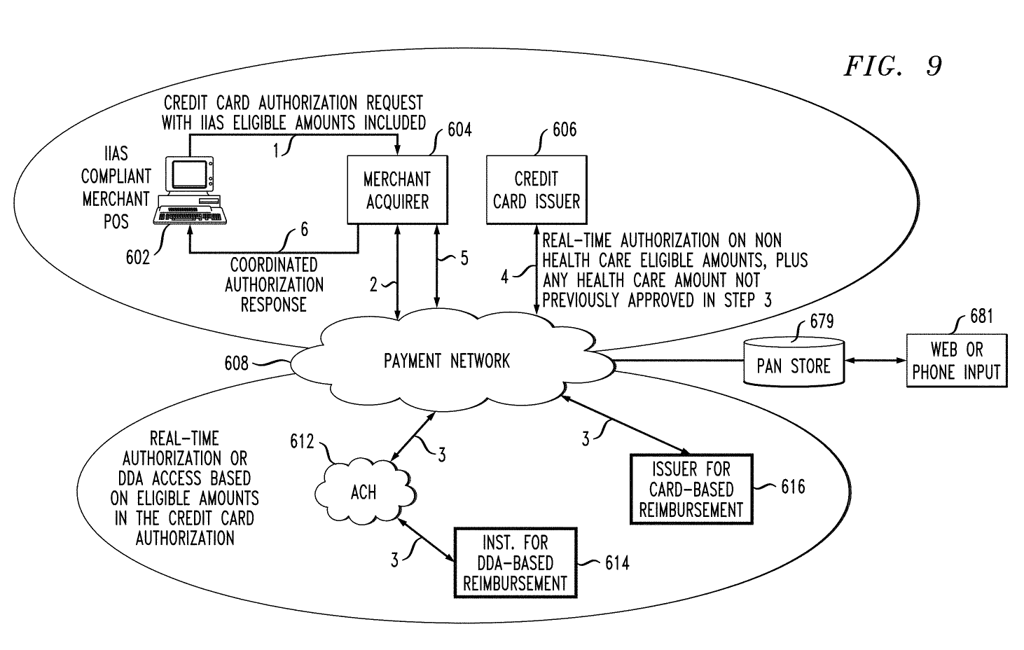

This embodiment is a variation from the second embodiment but processes the healthcare (or other eligible) amounts in real time with the authorization. Reference should be had to FIG. 8. The merchant 602 sends the properly formatted authorization request, along with eligible amounts, to the merchant acquirer 604 for processing, as per arrow 1 in FIG. 8. The acquirer 604 forwards the authorization request, with eligible amount fields, to payment network operator 608 for processing, as per arrow 2 in FIG. 8. Payment network operator 608 forwards the authorization request, without eligible amounts, to the issuer 606 of the general-purpose card for an authorization approval or decline decision, as per arrows 3A in FIG. 8 (for example, $70 ineligible items out of $100 total). The request to the issuer 606 will also include any reimbursable amounts that cannot be processed real-time (e.g., ACH processing for HSA). At the same time, as per arrows 3B in FIG. 8, the corresponding authorization for only the eligible amounts (for example, $30 eligible out of $100 total) will be sent to the health care (or other reimbursement) issuers (i.e., issuer 616 of a card-based account or entity 614 in the case of DDA based account). Payment network operator 608 will consolidate the responses and send a single response for the entire amount back to the acquirer 604 and merchant 602, as per arrows 4 and 5 in FIG. 8. The single response comes from the network operator 608 based on the responses received both from the healthcare (or other reimbursement) account owner 614, 616 and credit/debit card issuer 606. In at least some embodiments, in the event that part of the authorization amount is declined by the owning party, network 608 may employ payment message ability to send back partial approvals.

Sometimes, eligible amounts cannot be authorized in real time. For example, ACH may be problematic because it may take approximately three days (rather than seconds) to determine if money is present. In such a case, payment network operator 608 may include in the amount of the authorization to issuer 606 both the amount for ineligible items and the amount for eligible items that cannot be verified in real time. In an alternative, the payment network operator 608 includes in the amount of the authorization to issuer 606 only the amount for ineligible items, and assumes the risk of collecting the amounts for which real-time verification is not possible.

Thus, the flow of funds is as follows, in at least some instances. Network 608 send to issuer 606 an authorization/clearing message against the general-purpose account for only ineligible amounts and eligible amounts not capable of real time authorization. All eligible amounts are sent to the appropriate healthcare (or other reimbursement) account owner 614, 616. The network operator 608 is responsible for building an appropriate response back to merchant 602 based on the combined responses from issuers 606, 616. Issuers 606, 616 settle with the merchant 602 for the applicable amount. Institution 614 settles with the network operator 608, who then credits back the general-purpose account for the approved amount. Within network 608, given the teachings herein, this could be implemented within an existing clearing/settlement process, or via existing ISO messages to generate payment to a specific card number (referred to as a “Payment-to” transaction).

### Fourth Exemplary Embodiment

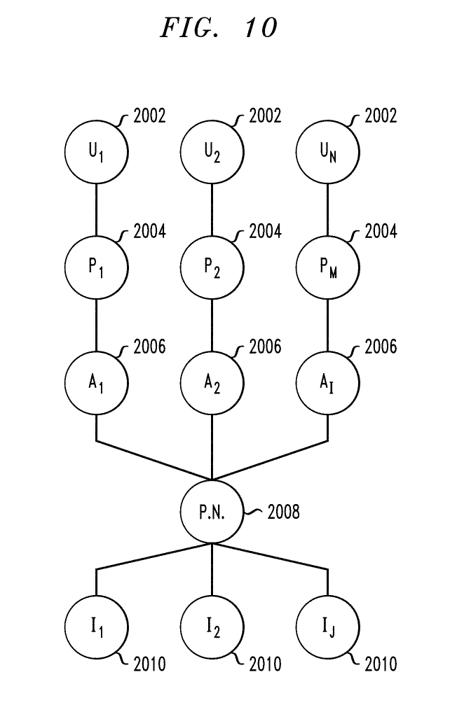

This embodiment is another variation from the second embodiment, but processes the eligible amounts in real time with the original authorization. Reference should be had to FIG. 9. As per arrow 1 in FIG. 9, the merchant 602 sends the properly formatted authorization request, along with eligible amounts, to the merchant acquirer 604 for processing. The acquirer 604 forwards the authorization request, with eligible amount fields, to payment network operator 608 for processing, as per arrow 2 in FIG. 9. As per arrows 3 in FIG. 9, payment network operator 608 forwards the reimbursement account authorization request for the eligible amount only, where possible (e.g. may not work for ACH). The subsequent authorization request sent to the issuer 606 for processing, as per arrow 4 in FIG. 9, will contain all non-eligible amounts plus any eligible amount previously unauthorized. Payment network operator 608 will generate a single authorization response based on the two authorizations, as per arrow 5 in FIG. 9. The final response can be returned to the issuer. Arrow 6 in FIG. 9 shows the coordinated credit card authorization response from the network operator 608. The single response comes from the network operator 608 based on the responses received both from the healthcare (or other reimbursement) account owner 614, 616 and credit/debit card issuer 606. In at least some embodiments, in the event that part of the authorization amount is declined by the owning party, network 608 may employ payment message ability to send back partial approvals.

Thus, the flow of funds is as follows. Network 608 send to issuer 606 an authorization/clearing message against the general-purpose account for all ineligible amounts, eligible amounts not capable of real-time authorization and eligible amounts capable of real-time authorization that were not approved by issuer 616. All eligible amounts are sent to the appropriate healthcare (or other reimbursement) account owner 614, 616. The network operator 608 is responsible for building an appropriate response back to merchant 602 based on the combined responses from issuers 606, 616. Issuers 606, 616 settle with the merchant 602 for the applicable amount. Institution 614 settles with the network operator 608, who then credits back the general-purpose account for the approved amount. Within network 608, given the teachings herein, this could be implemented within an existing clearing/settlement process, or via existing ISO messages to generate payment to a specific card number (referred to as a “Payment-to” transaction).

### Recapitulation

Note that as used in the claims, a “card” should be broadly construed to include a traditional card 102, 112, 150, as well as unconventional devices configured to act as a card (e.g., cell phone handset, fob, and the like). Given the discussion thus far, and particularly the discussion of the first and second embodiments above, it will be appreciated that, in general terms, a method, according to an aspect of the invention, includes the step of linking a general-purpose payment card product to a designated reimbursement account. In one or more embodiments, this linkage can be implemented based on the card number (PAN). Whichever entity (issuer 606 or network operator 608) implements the funding, splitting, and interface with the health care (or other reimbursement) entity should have access to the linkage information. In a preferred approach, a registration web site, call center (possibly with interactive voice response (IVR), or the like, generally represented as 681, is run by issuer 606 or network operator 608 for the user to register the association between the general purpose card and reimbursement account. The participating PANs are stored in a PAN database store 679. This database (or a local copy thereof) is made available (e.g., via a suitable network link) to the party who needs the information (e.g., issuer 606 in FIG. 6 or network operator 608 in FIGS. 7-9). The card holder will access the site 681 and register the general purpose card and the linked healthcare (or other reimbursement) account information, whether card- or DDA-based. When the appropriate party (issuer 606 or network operator 608) sees the transaction come in, they know based on the PAN to split the funding.

An additional step includes facilitating obtaining a payment card authorization request with a full amount and a reimbursement eligible amount included therein, based on a transaction with the payment card product at a merchant 602. This can be carried out, for example, by a merchant POS system communicating with network operator 608 using the payment network. A further step includes facilitating returning to the merchant a payment card authorization response from an issuer 606 of the payment card product. The payment card authorization response is based on the full amount. This step can be implemented, for example, using an issuer platform of issuer 606, via payment network 608. A still further step includes facilitating initiating a funding request (e.g., card- or DDA-based), for the reimbursement eligible amount, from the designated reimbursement account 614, 616. This step can be carried out by the issuer platform (embodiment 1) or a platform in network 608 (embodiment 2).

The payment card product and the designated reimbursement account are managed separately. “Managed separately” means that they are managed by different and unrelated entities, or in the case of an institution such as a large commercial bank that issues both credit cards and health care (or other reimbursement) accounts, they are handled separately within the institution, the payment card product is generally accepted for all kinds of purchases, and the reimbursement account is limited to reimbursement-eligible purchases.

In some instances (for example, the first embodiment), the funding request is initiated by the issuer of the payment card product. In such cases, clearing and settlement can proceed, for example, as described above with regard to the flow of funds in embodiment 1.

In other instances (for example, the second embodiment), the funding request is initiated by the operator of payment network 608, which carries the authorization request and the authorization response. In such cases, clearing and settlement can proceed, for example, as described above with regard to the flow of funds in embodiment 2.

The payment card product could be a credit card, a debit card, a prepaid card, or a stored balance card. The designated reimbursement account could be, for example, a designated health care account, or a government benefit account, such as food stamps or the like.

In a preferred but non-limiting approach, the reimbursement eligible amount is an IIAS eligible amount.

Given the discussion thus far, and particularly the discussion of the third and fourth embodiments above, it will be appreciated that, in general terms, another exemplary method, according to another aspect of the invention, includes the step of linking a general-purpose payment card product to a designated reimbursement account (e.g., card- or DDA-based), in a manner similar to that described above. An additional step includes facilitating obtaining a payment card authorization request with a full amount and a reimbursement eligible amount included therein, based on a transaction with the payment card product at a merchant 602, again, in a manner similar to that described above.

A further step includes facilitating interception of the request by an operator of a payment network 608; for example, using a payment network platform. Further steps, by the operator of the payment network 608, include facilitating initiating first and second operator authorization requests. The first request is for the reimbursement eligible amount, from an issuer entity (e.g., 614 or 616) associated with the designated reimbursement account. The second request is for the full amount less the reimbursement eligible amount, but plus any uncertain portion of the reimbursement eligible amount, as defined below, from an issuer of the payment card product. These steps can also employ a payment network platform.

Yet a further step includes facilitating returning to the merchant a coordinated payment card authorization response from the operator of the payment network. The payment card product and the designated reimbursement account are managed separately, as discussed above.

In some instances (for example, the third embodiment), the step of facilitating the first operator authorization request and the step of facilitating the second operator authorization request are carried out simultaneously. In such a case, the aforementioned uncertain portion may include eligible amounts not capable of real time authorization.

In other instances (for example, the fourth embodiment), the step of facilitating the first operator authorization request is carried out prior to the step of facilitating the second operator authorization request, and the step of facilitating the second operator authorization request is carried out only after a response is received to the first operator authorization request. In such a case, the aforementioned uncertain portion may include eligible amounts not capable of real-time authorization and eligible amounts capable of real-time authorization that were not approved by issuer 616.

Again, the payment card product could be a credit card, a debit card, a prepaid card, or a stored balance card; and the designated reimbursement account could be, for example, a designated health care account or a government benefit account, such as food stamps or the like. Again, in a preferred but non-limiting approach, the reimbursement eligible amount is an IIAS eligible amount.

In another aspect, an exemplary apparatus includes a registration site module; a payment network platform module, coupled to the registration site module (directly as in FIGS. 7-9 or indirectly as in FIG. 6), and an issuer platform module, coupled to the payment network platform module. Each of the modules includes a memory, at least one processor coupled to the memory, and a corresponding distinct software module, embodied on a tangible, computer-readable recordable storage medium. See FIG. 5 and accompanying discussion below. The corresponding software modules are executable by the corresponding processors to carry out one or more method steps as described.

### System and Article of Manufacture Details

The invention can employ hardware and/or hardware and software aspects. Software includes but is not limited to firmware, resident software, microcode, etc. Software might be employed, for example, in connection with one or more of the blocks in FIGS. 1, 2 and 6-10; a terminal 122, 124, 125, 126; a transfer engine 212, a processing center 140, 142, 144 (optionally with data warehouse 154) of a merchant, issuer, acquirer, processor, or operator of a network 210, 2008 operating according to a payment system standard (and/or specification); any of the platforms described herein; and the like. It is presently believed that engine 212 can be advantageously implemented, e.g., in software running on a general purpose computer. Software running on a computer can also be used for building the database as shown in FIG. 4, implementing issuer and/or acquirer (or other) platforms, or implementing the data and logic flows on FIGS. 6-9. Firmware might be employed, for example, in connection with payment devices such as cards 102, 112.

FIG. 5 is a block diagram of a system 500 that can implement part or all of one or more aspects or processes of the present invention. As shown in FIG. 5, memory 530 configures the processor 520 (which could correspond, e.g., to processor portions 106, 116, 130, processors associated with any of the blocks in FIGS. 1, 2 and 6-10, processors of terminals, or processors of remote hosts in centers 140, 142, 144) to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices (e.g., displays, mice, keyboards, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is intended to encompass a recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, e.g., by processing capability on elements 102, 112, 122, 124, 125, 126, 140, 142, 144, any of the blocks in FIGS. 1, 2 and 6-10, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention, such as, for example, the aforementioned terminals 122, 124, 125, 126, processing centers 140, 142, 144 with data warehouse 154, processors in any of the blocks in FIGS. 1, 2 and 6-10, or payment devices such as cards 102, 112 can make use of computer technology with appropriate instructions to implement method steps described herein. By way of further example, a terminal apparatus 122, 124, 125, 126 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of yet a further example, an apparatus for electronic payment validation (such as engine 212), an apparatus for building a database useful in facilitating electronic payment validation, and/or an apparatus to carry out one or more techniques such as those in FIGS. 6-9 could include a memory and at least one processor coupled to the memory. The processor can be operative to perform one or more method steps described herein (e.g., in FIGS. 2-4 and 6-9), or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a tangible computer readable storage medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include a registration site module at location 681; a merchant point of sale system module at location 602, which can run, for example, on a merchant terminal and/or a merchant server connected to one or more merchant terminals; an issuer platform module at location 606 (for example, running on one or more hardware processors of an issuer host); a payment network platform module at location 608 (for example, running on one or more hardware processors within network 608); optionally a_transfer engine software module, optionally with a translation database and/or an approved promotional item database, at locations 212; a reimbursement issuer platform module at location 616 (for example, running on one or more hardware processors of a reimbursement issuer host); and a reimbursement institution platform module at location 614 (for example, running on one or more hardware processors of a reimbursement institution host). The method steps can then be carried out using the distinct software modules of the system, as described above, executing on the one or more hardware processors. Further, a computer program product can include a tangible computer-readable recordable storage medium (inclusive of multiple such media) with code adapted to be executed to carry out one or more method steps described herein, including the provision of the system with the distinct software modules.

Computers discussed herein can be interconnected, for example, by one or more of network 138, 210, 608, 2008 another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic depicted in the flow charts, such as the logic described with regard to FIGS. 6-9.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. (canceled)

2. A method for funding a card payment partly from a designated reimbursement account and partly from an issuer of a general-purpose payment card product that is used for said card payment, said method comprising the steps of:
linking said payment card product to said designated reimbursement account;
facilitating obtaining a payment card authorization request with a full amount and an IIAS reimbursement eligible amount included therein, based on a transaction with said payment card product at a merchant;
facilitating interception of said request by an operator of a payment network;
facilitating initiating a first operator authorization request, by said operator of said payment network, for said IIAS reimbursement eligible amount, from an issuer entity associated with said designated reimbursement account;
facilitating initiating a second operator authorization request, by said operator of said payment network, for said full amount less said IIAS reimbursement eligible amount, but plus any uncertain portion of said IIAS reimbursement eligible amount, from an issuer of said payment card product; and
facilitating returning to said merchant a coordinated payment card authorization response from said operator of said payment network;
wherein said payment card product and said designated reimbursement account are managed separately.

3. The method of claim 2, wherein said step of facilitating said first operator authorization request and said step of facilitating said second operator authorization request are carried out simultaneously.

4. The method of claim 2, wherein said step of facilitating said first operator authorization request is carried out prior to said step of facilitating said second operator authorization request, said step of facilitating said second operator authorization request being carried out only after a response is received to said first operator authorization request.

5. The method of claim 2, wherein said payment card product comprises one of a credit card, a debit card, a prepaid card, and a stored balance card.

6. The method of claim 2, wherein said designated reimbursement account comprises a designated health care account.

7. The method of claim 2, wherein said designated reimbursement account comprises a government benefit account.

8. The method of claim 2, wherein said IIAS reimbursement eligible amount comprises an inventory information approval system eligible amount.

9. The method of claim 2, wherein said designated reimbursement account is card-based.

10. The method of claim 2, wherein said designated reimbursement account is demand deposit account based.

11. The method of claim 2, further comprising providing a system, wherein the system comprises distinct software modules, each of the distinct software modules being embodied on a computer-readable storage medium, and wherein the distinct software modules comprise a registration site module, a merchant point of sale system module, an issuer platform module, and a payment network platform module;
wherein:
said linking is carried out by said registration site module executing on at least one hardware processor;
said facilitating obtaining said payment card authorization request is carried out by said merchant point of sale system module executing on said at least one hardware processor;
said facilitating interception of said request is carried out by said payment network platform module executing on said at least one hardware processor;
said facilitating initiating said first operator authorization request is carried out by said payment network platform module executing on said at least one hardware processor;
said facilitating initiating said second operator authorization request is carried out by said payment network platform module executing on said at least one hardware processor; and
said facilitating returning to said merchant said payment card authorization response is carried out, at least in part, by said payment network platform module executing on said at least one hardware processor;

12. An apparatus for funding a card payment partly from a designated reimbursement account and partly from an issuer of a general-purpose payment card product that is used for said card payment, said apparatus comprising:
a registration site module comprising a registration site memory, at least one registration site processor coupled to said registration site memory, and a distinct registration site software module, embodied on a registration site tangible computer-readable recordable storage medium, executable by said registration site processor to link said payment card product to a designated reimbursement account;
a payment network platform module, coupled to said registration site module, and comprising a payment network platform memory, at least one payment network platform processor coupled to said payment network platform memory, and a distinct payment network platform software module, embodied on a payment network platform tangible computer-readable recordable storage medium, executable by said payment network platform processor to:
receive a payment card authorization request with a full amount and an HAS reimbursement eligible amount included therein, based on a transaction with said payment card product at a merchant;
facilitate initiating a first operator authorization request for said HAS reimbursement eligible amount from an issuer entity associated with said designated reimbursement account; and
facilitate initiating a second operator authorization request for said full amount less said HAS reimbursement eligible amount, but plus any uncertain portion of said HAS reimbursement eligible amount, from an issuer of said payment card product; and
an issuer platform module, coupled to said payment network platform module, and comprising an issuer platform memory, at least one issuer platform processor coupled to said issuer platform memory, and a distinct issuer platform software module, embodied on an issuer platform tangible computer-readable recordable storage medium, executable by said issuer platform processor to facilitate returning to said merchant a payment card authorization response;
wherein:
said payment card product and said designated reimbursement account are managed separately; and
at least one of said issuer platform module and said payment network platform module is configured to facilitate initiating a funding request, for said HAS reimbursement eligible amount, from said designated reimbursement account.
